(19) United States
(12) Patent Application Publication
(10) Pub. No.: US 2008/0120690 A1
(43) Pub. Date: May 22, 2008

(54) Client enforced network tunnel vision

(75) Inventors: Rebecca A. Norlander, Seattle, WA (US); Pradeep Bahl, Redmond, WA (US); Scott A. Field, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/601,155

(22) Filed: Nov. 17, 2006

(51) Int. Cl. G06F 21/00

(52) U.S. Cl. 726/1; 726/3

(57) ABSTRACT

If a service detects that a state of a computer system deviates from an acceptable state, the computer system can be prevented from accessing network resources or locations, except for those network resources or locations that would bring the state into compliance. Monitored states can include whether applications or the operating system have been properly purchased, whether they have been properly updated, and whether they are being properly used given the environment of their usage. Network restrictions can be implemented through a parental control mechanism, a domain name service mechanism, or other like mechanisms, and can include redirection to appropriate network resources or locations.

### BACKGROUND

Traditionally, computer software is designed to enable the user to perform the actions that the user desires to perform. In some cases, however, the user may, either by accident or by intent, perform actions which may be detrimental or not perform actions which may be beneficial. In extreme cases, such actions or inactions may even be illegal or inadvisable, respectively. For example, the user may ignore important updates, leaving the software vulnerable to malicious software. As another example, the user may be using the software, even though the user has not purchased a license to do so. Unpaid-for usage of software is commonly called “software piracy.”

By some estimates, over a third of all software programs in existence are “pirated.” Downloading of trial software from easily accessible network locations may only further software piracy, since the relative anonymity of many types of network access can serve to encourage unlawful behavior. Likewise, software that is freely distributed, but requires a subsequent payment for authorized use, often referred to as “shareware” software, can also suffer from software piracy.

In an effort to encourage authorized, paid-for usage, some software will not let the user save their work once a trial period has expired and there is no evidence that a license for that software has been properly purchased. Other software may not even execute until the user provides evidence of a properly purchased license for that software. However, some users may not be aware that the software was not properly purchased. For example, one member of a family sharing a single computer may download software on a trial basis without telling the other members. Likewise, students may use shareware programs without the teacher or other school administrator being aware of the fact that the shareware fee was never paid.

Many users are likewise unaware of critical updates to the software that they are using. A user's failure to install critical updates can be detrimental, not just to the user, but to others as well. For example, a user's failure to install critical security patches can allow malicious software to overtake individual programs, or even the user's whole computer, and use that computer in attacks against other computers. Similarly, a user's failure to install critical compatibility patches can cause the corruption of others' data. Lastly, the costs of ignored updates are often very high for software manufacturers and distributors, who must bear the burden of fielding thousands, if not millions, of extra user complains regarding the software product, which could have been avoided if the users' had only installed the necessary updates.

### SUMMARY

A service can monitor the state of one or more computer software applications on a computing device and can similarly monitor the state of the operating system of the computing device. The service can be triggered on a periodic basis by other periodic events, such as a nightly anti-virus scan, or it can leverage other periodic events and have such events collect the state information themselves. Alternatively, the service can remain vigilant, and can check the relevant state based on particular events, such as a change in the hardware or software configuration of the computing device.

If the service finds that the monitored state has deviated from an acceptable range, the service can limit the computing device's ability to use various network resources. If the monitored state includes the legitimacy or security of computer software installed on the computing device, including the legitimacy or security of the operating system itself, the service can limit the computing device to only those network resources needed to properly purchase a license, or obtain the necessary security updates, for that software. Alternatively, if the monitored state includes the “current-ness” of computer software installed on the computing device, including the operating system itself, the service can limit the computing device to only those network resources needed to update the software, or install a patch for the software.

The limitations to the computing device's ability to use various network resources can include the ability to redirect network requests. Thus, a user attempt to use a network resource would not receive an error message. Instead, the user would automatically be redirected to an appropriate network location at which the user could purchase a license, download updates or patches, or otherwise perform actions that would either correct the monitored state or maintain the monitored state in a proper condition. As such, redirections could be used to ensure that the monitored state achieves a proper condition as soon and as conveniently as possible.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary computing device;

FIG. 2 is a block diagram of an exemplary relationship between monitored, monitoring, and limiting processes;

FIG. 3 is a flowchart illustrating an exemplary process for enforcing limitations based on a detected state; and

FIG. 4 is a flowchart illustrating an exemplary process for providing redirection.

### DETAILED DESCRIPTION

The following description relates to enforcing a form of “tunnel vision” on a computing system, by limiting the system's access to network resources, based on the state of the system. In one embodiment, a service detects that the state of the system is no longer acceptable and, as a result, appropriately limits the system's access to network resources. For example, if the service detects that a software application program has not been properly licensed, the service can, either directly or indirectly, instruct the network access components of the system to deny access to any network resources except those by which the software application program can be properly licensed. As another example, if the service detects that the operating system is lacking one or more critical updates, the service can, either directly or indirectly, instruct the network access components of the system to deny access to any network resources except those by which the critical updates can be downloaded and installed.

In another embodiment, a service detects that the state of the system is no longer acceptable and, as a result, limits the system's access to network resources by redirecting requests to appropriate network resources. For example, if the service detects that a software application program has not been properly licensed, the service can, either directly or indirectly, instruct the network access components of the system to redirect some or all network access requests to a network location at which the software application program can be properly licensed. As another example, if the service detects that the operating system is lacking one or more critical updates, the service can, either directly or indirectly, instruct the network access components of the system to redirect some or all network access requests to a network location at which the critical updates can be obtained.

The state of the system being monitored by the service can include transient conditions, such as the current time, the location of the computing system, or the network connection currently being used by the computer system. Consequently, another embodiment can restrict or redirect network access only during predefined times, or when the computing device is connected through predefined service providers. For example, network access requests directed to inappropriate material, such as gambling sites or sites with adult-oriented content can be restricted, or redirected, during normal business hours.

The techniques described herein focus on, but are not limited to, the mechanisms by which the state of the system is detected, monitored, and compared to a benchmark, and mechanisms by which the network access of the computer system is restricted or redirected. In one embodiment, a service can monitor the state of the system on a periodic basis. Such periodic monitoring can be self-triggered, or it can be triggered by other periodic processes such as anti-viral scanners. In an alternative embodiment, the service can monitor the state on the system on an ongoing, or continual basis, such as by checking the state of the system each time a system change is detected. System changes can be changes to the physical hardware of the computing system or changes to the installed computer software or other relevant software configuration of the system.

Network access restrictions can, in one embodiment, include denying access to network resources other than those network resources that can correct, or remove, whatever state triggered the restrictions in the first place. Such network resources can include access to network locations such as World Wide Web sites, File Transfer Protocol (FTP) sites, or email servers. In an alternative embodiment, network access restrictions can include redirecting access from prohibited network resources to those work resources that can correct, or remove, whatever state triggered the restrictions in the first place.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing devices, as the mechanisms may also be practiced in distributed computing environments where tasks are performed by remote processing devices that are linked through a communications network. In a distributed computing environment, program modules may be located in both local and remote memory storage devices.

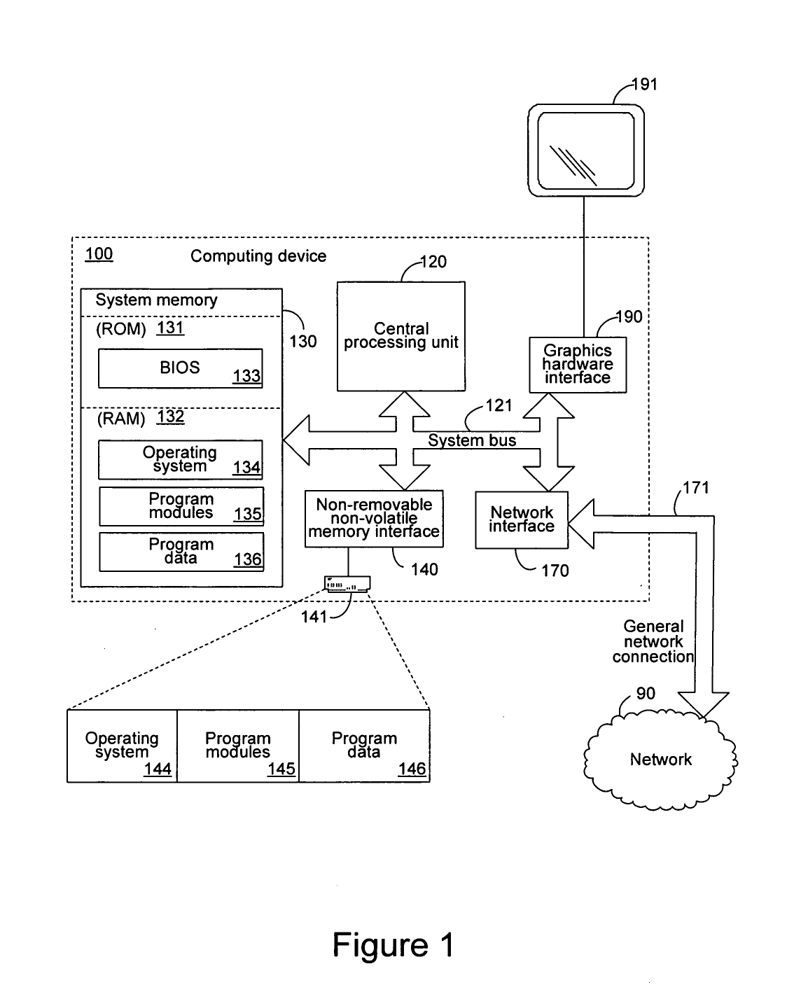

With reference to FIG. 1, an exemplary computing device 100 is illustrated. The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. The computing device 100 can optionally include graphics hardware, including, but not limited to, a graphics hardware interface 190 and a display device 191.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 1 illustrates an operating system 134, other program modules 135, and program data 136.

The computing device 100 may also include other removable/non-removable, volatile/nonvolatile computer storage media. By way of example only, FIG. 1 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 1, provide storage of computer readable instructions, data structures, program modules and other data for the computing device 100. In FIG. 1, for example, hard disk drive 141 is illustrated as storing an operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For simplicity of illustration, the computing device 100 is shown in FIG. 1 to be connected to a network 90 that is not limited to any particular network or networking protocols. The logical connection depicted in FIG. 1 is a general network connection 171 that can be a local area network (LAN), a wide area network (WAN) or other network. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

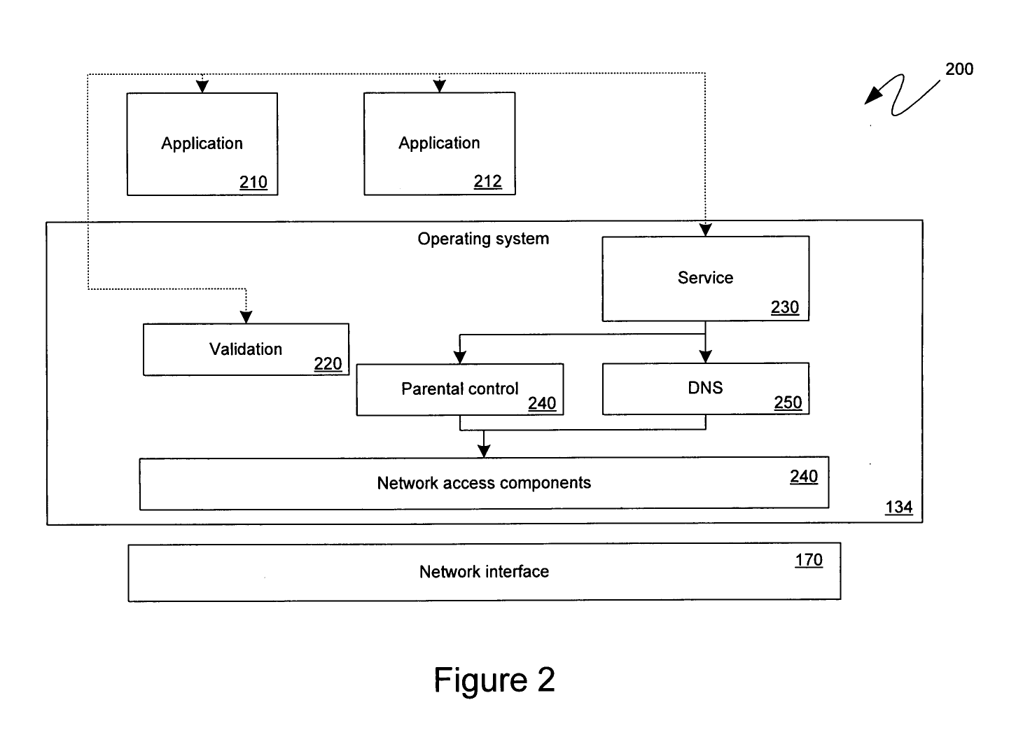

An exemplary set of processes that can be executing on computing device 100 are illustrated in FIG. 2 in process diagram 200. The operating, system 134 acts as a hosting process, providing the necessary structure for applications and services to execute, including applications 210 and 212 and a service 230. The operating system 134 of computing device 100 can comprise network access components 240 that interact with network hardware, such as the network interface 170, in order to provide network connectivity to the computing device 100. Network access components 240 can include protocol stacks, such as the ubiquitous Transmission Control Protocol and Internet Protocol (TCP/IP) stacks, and can likewise include network socket modules, and other like network access components.

In a modern operating system, various higher level processes that are part of the operating system, can control the network access components. The operating system 134 of FIG. 2 illustrates two such processes: a parental control process 240 and a Domain Name Service (DNS) process 250. The DNS process 250 provides, and maintains, correlating information between a colloquial network location address, and a specific network location identifier, traditionally specified as a series of numbers. Thus, a DNS process can link an application program requesting a web page at a colloquial network location address of “www.someplace.com/somepage.html” to the specific IP address of the hosting computer, such as 203.165.10.11. A DNS process need not be used if the network location is requested directly by specifying a specific network location identifier, such as an IP address.

The parental control process 240 provides mechanisms by which specific network resources can be blocked for specific users. Traditionally, a parental control process 240 is used by an administrator parent to prevent non-administrator child users from accessing objectionable material. For example, a parental control process 240 can prevent a web browser application operated by a child from accessing web sites directed to adult-oriented materials.

The operating system 134 can also include a validation process 220 that can monitor the validity of the installation of the operating system itself. Such a validation process 220 typically comprises mechanisms by which identifying information can be transmitted to a central repository to verify the validity of the installation of the operating system 134. Some operating systems may additionally use the validation process 220 when one or more hardware components of the computing device 100 change to such an extent that the operating system cannot determine whether it is still installed on the same computing device.

The operating system 134 can host applications 210 and 212 by providing the necessary interfaces for the applications 210 and 212 to execute on the underlying CPU 120 and utilize the other hardware resources of the computing device 100. The operating system 134 can likewise host a service 230 which can monitor one or more installed applications 210 and 212, the operating system 134, such as through the validation process 220, and any other state of the computing device 100.

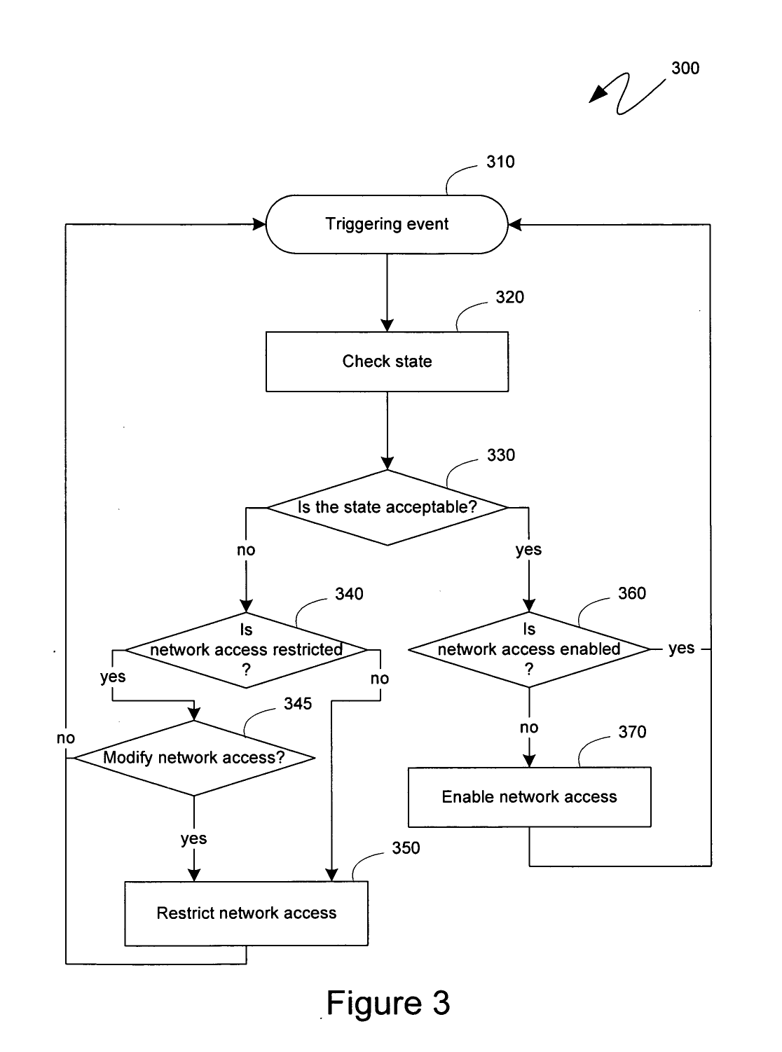

Turning to FIG. 3, the operations of service 230 are described in further detail in conjunction with flow diagram 300. In one embodiment, the service 230 can perform periodic monitoring by checking applications 210, 212, validation process 220, or any other state on a periodic basis initiated by the service itself. The service 230 can also perform periodic monitoring by triggering off of another periodic service, such as an anti-virus or anti-spyware program. Thus, as illustrated by flow diagram 300, the service 230 can receive a triggering event at step 310 that can be either associated by an external process, such as the aforementioned programs, or it can be a self-trigger, such as a timer process. Once triggered at step 310, the service 230 can check the state of a monitored application, operating system or other component at step 320.

In another embodiment, a triggering event 310 can include hardware or software changes to the computing device 100. Consequently, the service 230 can be said to be continuously monitoring, since any relevant change to the hardware of the computing device 100, or the software installed thereupon, can trigger the service 230, irrespective of the time at which such a change takes place. Relevant changes can include the installation or removal of hardware, especially hardware that can raise a question as to whether the underlying computing device 100 has itself been replaced by a different, similar computing device. Relevant changes can likewise include the installation or removal of one or more software applications, especially applications being monitored by service 230, such as applications 210 or 212.

Once triggered, the service 230 can, at step 330, compare the state of a monitored application, operating system or other element to some predetermined benchmark to determine if the state is acceptable. As an example, the service 230 can monitor the state of the validation process 220 of the operating system 134 to verify that the operating system is properly purchased and installed. Thus, if the validation process 220 is not able to validate the installation of the operating system 134, its state can reflect such a failure. Service 230 will detect such a “fail” state at step 320. Subsequently, the service 230 can compare, at step 330, monitored “fail” state with an acceptable state, such as a “success” state. The lack of equivalence between the monitored state and the acceptable state can cause the service 230, at step 330, to determine that the “fail” state is an unacceptable state. In another embodiment, the validation process 220, or another component of the operating system 134, can indicate that the operating system is missing critical updates, such as security updates. When the service 230 checks such a component at step 320, it can detect a “outdated” state. Comparing the monitored “outdated” state with an acceptable state, such as an “updated” state, at step 330, can again cause the service 230 to determine that the “outdated” state is an unacceptable state.

The state checked by service 230, at step 330, is not limited to validations of proper, up-to-date installations for which a license has been purchased. For example, the service 230 can check whether a request from an application, such as application 210 or 212, is proper given the environment in which the request is made. A request for a gambling web page made during normal business hours, for example, can be deemed to be an unacceptable state at step 330. Likewise, a request for an adult-oriented web page made by a child user can similarly be deemed to be an unacceptable state at step 330.

In determining, at step 330, whether a monitored state is acceptable, a comparison can be made to benchmark states that are locally stored on the computing device 100, such as with service 230. Alternatively, a comparison can be made to benchmark states that are dynamically obtained by service 230 from external locations, such as centralized monitoring agents or other network servers. Using such dynamic benchmarks enables the service 230 to respond to new threats and react to new situations. As an example, a website may have previously been deemed to be acceptable to visit during business hours, but a subsequent change to the website may have since rendered it inappropriate for viewing during business hours. Such a website could be added to a centralized list of websites that should not be accessed during business hours, for example. A subsequent attempt to access such a website can result in service 230 comparing, at step 330, the requested website to the centralized list of websites that are not to be viewed during business hours if the request is detected by the service 230 during such hours.

If the service 230 determines, through step 330, that the monitored state is acceptable, it can verify, at step 360, that network access has not previously been restricted. If network access is properly enabled, the service 230 can loop back to step 310, and again resume either continuous or periodic monitoring of the relevant states. However, if network access was previously restricted, then at step 370 the service 230 can request that network access be properly enabled. Once network access has been enabled, the service 230 can loop back to step 320, or optionally step 310 if the service's monitoring is externally triggered.

If the service 230 determines, at step 330, that the monitored state is not acceptable, it can seek to restrict or redirect network access through steps 340, 345 and 350. As an initial matter, the service 230 can determine at step 340 whether network access has already been restricted. If the network access has already been restricted, then the service can further check at step 345 if the current restriction is appropriate. If no modification of the network restrictions already in place is appropriate at step 345, the service 230 can loop back to step 310, and again resume either continuous or periodic monitoring of the relevant states. If, however, a modification of the current network restriction is determined to be appropriate at step 345, the service 230 can proceed to step 350 and place a subsequent restriction on the network access. For example, if network access had previously been restricted because the operating system 134 had been found to lack critical updates, then than prior network restriction could still have allowed network access to the web sites or other network locations from which such critical updates could be downloaded. Subsequently, the service 230 could find, at step 330, that a monitored state was not acceptable because an application, such as application 210, was not properly licensed. In such a case, the restriction that is in place may not be appropriate given the new unacceptable state and, consequently, the service 230 could decide, at step 345, to proceed to step 350 and apply a second network access restriction or replace the previous restriction with a new one. Returning to the above example, the existing network access restriction could be modified to allow, not only network access to the network locations from which the critical updates for the operating system 134 could be downloaded, in order to cure the initial unacceptable state, but to also allow network access to the network locations from which a proper license could be purchased for the application 210, thereby curing the subsequent unacceptable state.

If the service 230 determines, at step 330, that a monitored state is not acceptable, and determines, at step 340, that network access has not been restricted, then at step 350, the service 230 can either request, or can itself, restrict network access as appropriate. In one embodiment, the service 230 can itself communicate directly with the network access components 240 of FIG. 2 so as to restrict network access. In an alternative embodiment, the service 240 can interoperate with operating system components, such as the DNS 250 or the parental control 240 and request that these components implement an appropriate restriction of network access.

In one embodiment, a restriction of network access prevents any network-capable application from reaching any network location except for those network locations that can remedy the unacceptable state. Thus, as an example, if a monitored state is unacceptable because an application, such as applications 210 or 212, or because the operating system 134 itself has not been properly licensed, then those network locations that would enable a user to purchase a proper license can remain accessible from the computing system 100. Access to other network locations, however, could be restricted. In an alternative embodiment, only common types of network access could be restricted. Thus, strictly by way of example, Hyper-Text Transfer Protocol (HTTP) requests, commonly used for accessing web pages, can be restricted to only those web pages that can remedy the unacceptable state, while operations such as network time synchronization requests that are needed for proper functioning of the OS and specific applications could remain enabled irrespective of the network location being communicated with. In a further alternative embodiment, all network locations could be restricted, irrespective of accessing protocol.

One mechanism by which the service 230 can restrict network access is by interfacing with the DNS 250. For example, the service 230 can point the DNS 250 to a special hosts file and can flush the cache of the DNS. The service 230 can likewise instruct the DNS 250 to ignore any network name resolution query that is not directed to a network location that can repair the unacceptable state. Should the service 230 desire to re-enable network access, it can simply point the DNS 250 back to the original hosts file and can remove any restrictions limiting responses to name resolution queries.

As will be recognized by those skilled in the art, DNS 250 is not the only name service agent that may be available on a computing device 100. Other network names are resolved into specific network addresses by name service agents that can be specific to the protocols or implementations of the relevant network. Consequently, while the above descriptions have focused on DNS, nothing in the above descriptions is intended to be limited only to DNS, as the procedures described are equally applicable, and similarly implementable, using any network name service agent.

Another mechanism by which service 230 can restrict network access is by interfacing with the parental control mechanism 240, or similar network filtering component. In one embodiment, the parental control mechanism 240 can be modified to allow approved applications or services to block network resources for all users of the computing device 100, and not just non-administrator users. Such a modified parental control process 240 can be used by the service 230 to limit access to network resources, including web sites, FTP sites and email servers. More specifically, the service 230 can instruct the parental control mechanism 240 to enable access only to those network resources, such as web pages or FTP sites, that can provide a way by which the unacceptable state can be remedied. Once the unacceptable state is remedied, the service 230 can instruct the parental control mechanism 240 to re-enable network access. Furthermore, because, traditionally, parental control mechanism 240 hooks commonly used network access components, it can provide filtering for many common application programs, including web browsers and email programs.

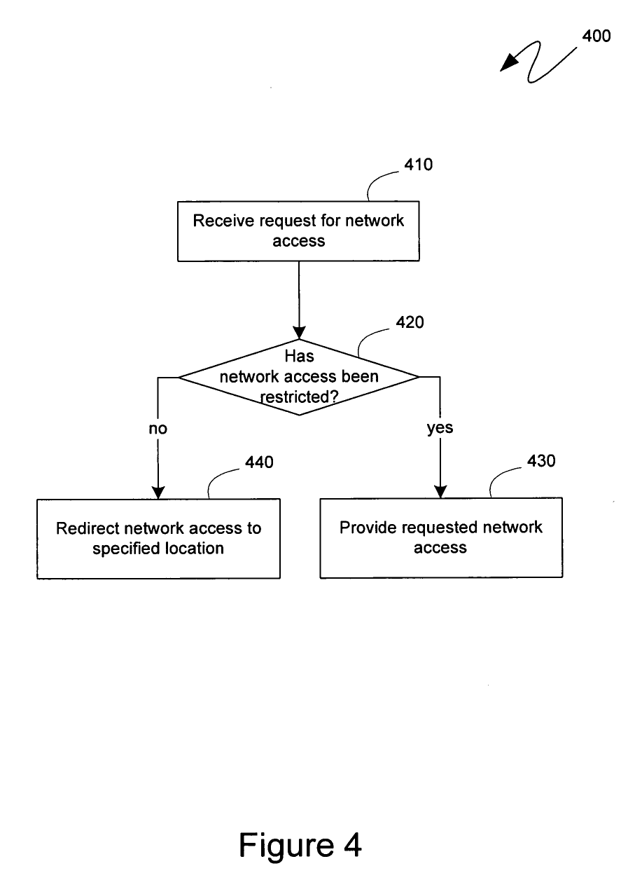

Turning to FIG. 4, flow diagram 400 illustrates a type of restriction of network access; specifically through redirection. If, at step 350 of flow diagram 300, the service 230 restricts network access, then flow diagram 400 illustrates the procedures that can be performed by the service 230, if it is performing the network restriction itself, or that can be performed by the parental control mechanism 240 or DNS 250, or any like network component.

Initially, at step 410, a request for network access is received. Subsequently, a determination can be made at step 420 whether network access has been restricted. If network access has not been restricted, then, at step 430, the network access that was requested at step 410 can be provided to the requesting application, service or component. However, if network access has been restricted, at step 440, the network access request can be redirected to an appropriate location.

If the DNS 250 was used by service 230 to implement a network access restriction, the DNS 250 can likewise be used to redirect network access requests to an appropriate location. As an example, if the monitored state was found to be unacceptable because the operating system 134 lacked a critical update, the DNS cache and the local hosts file can be modified to identify a network location at which the critical operating system update can be obtained. Consequently, a request for any network name address mapping can return the location at which the critical updates can be obtained. For example, if a user needed to install critical updates from a web page at www.os.com/criticalupdates.html, and the user instead requested a different web page, such as www.someplace.com/somepage.html, the DNS could return the specific network address of the www.os.com/criticalupdates.html page due to the modifications to the cache and to the hosts file and instructions to the DNS name agent. The user's web browser, therefore, would display www.os.com/criticalupdates.html, even though the user requested www.someplace.com/somepage.html.

If the parental control mechanism 240 was used, the parental control mechanism could be instructed to perform the network redirection. In one embodiment, a modified parental control mechanism 240 could export interfaces by which network redirection can be set up by specifying the site to which requests are to be redirected, and optionally, specifying other circumstances, such as if the redirection is only to occur during specific hours or based on other environmental factors.

To avoid user confusion, the user can be notified of the network access restrictions via a number of user interface elements. In one embodiment, the user can be notified of network access restrictions via user interface elements presented within the context of the application that had requested network access, and had been denied. Redirection provides one mechanism by which such an “in-band” user interface can be presented. Specifically, network access requests can be redirected to individually created local locations that provide the relevant information to the user. Returning to the above example of critical operating system updates, the DNS 250 or the parental control mechanisms 240 can redirect requests for any web page, except for the www.os.com/criticalupdates.html page, to a local web page that contains a notification to the user, and a link to the www.os.com/criticalupdates.html page. In such a manner, the user would receive a notification through the web browser that the user was interacting with.

An alternative approach contemplates the usage of “out-of-band” notifications, such as balloon notifications or alert windows. Returning again to the above example of critical operating system updates, a request by the user, through a web browser, for a page other than the www.os.com/criticalupdates.html page can simply fail, with a balloon notification appearing from an appropriate section of the operating system's user interface, informing the user of the reason for the failure the user had just experienced within the context of the web browser. Alternatively, the user could be notified through an alert notification that presents itself on top of the browser user interface, though such a notification need not exist in the browser process space, and can have been presented by an external process, such as the service 230.

As can be seen from the above descriptions, tunnel vision can be enforced upon a computing device to encourage users to more quickly bring the monitored state of the computing device into compliance. In view of the many possible variations of the subject matter described herein, we claim as our invention all such embodiments as may come within the scope of the following claims and equivalents thereto.

We claim:

1. One or more computer-readable media comprising computer-executable instructions for restricting network access based on one or more monitored states, the computer-executable instructions directed to steps comprising:
monitoring the one or more monitored states;
comparing the one or more monitored states to one or more benchmark states indicating acceptable states;
restricting network access if the comparing indicates that the one or more monitored states are not acceptable; and
re-enabling network access if the one or more monitored unacceptable states become acceptable.

2. The computer-readable media of claim 1, wherein the restricting network access comprises allowing network access directed to network resources that are necessary for rendering acceptable the one or more monitored unacceptable states.

3. The computer-readable media of claim 1, wherein the restricting network access comprises redirecting network access to network resources that are necessary for rendering acceptable the one or more monitored unacceptable states.

4. The computer-readable media of claim 1, wherein the benchmark states are dynamically obtained from an external source.

5. The computer-readable media of claim 1, wherein the restricting network access comprises modifying a network name service agent configuration and cache.

6. The computer-readable media of claim 1, wherein the restricting network access is performed by a parental control mechanism.

7. The computer-readable media of claim 1, wherein the comparing comprises determining if an appropriate license has been purchased.

8. The computer-readable media of claim 1, wherein the comparing comprises determining if one or more critical updates have been installed.

9. A method of enforcing a policy, the method comprising the steps of:
monitoring one or more monitored states associated with the policy;
comparing the one or more monitored states to one or more benchmark states selected according to the policy;
restricting network access if the comparing indicates that the one or more monitored states are not in conformance with the policy; and
re-enabling network access if the one or more monitored states changes to conform with the policy.

10. The method of claim 9, wherein the restricting network access comprises allowing network access directed to network resources that are necessary for modifying the one or more monitored states so as to comply with the policy.

11. The method of claim 9, wherein the restricting network access comprises redirecting network access to network resources that are necessary for modifying the one or more monitored states so as to comply with the policy.

12. The method of claim 9, wherein the benchmark states are dynamically obtained from an external source.

13. The method of claim 9, wherein the policy is directed to prevention of software piracy, and wherein further the comparing comprises determining if an appropriate license has been purchased.

14. The method of claim 9, wherein the policy is directed to prevention of the spread of malicious software, and wherein further the comparing comprises determining if one or more critical updates have been installed.

15. The method of claim 9, wherein the policy is directed to prevention of inappropriate behavior, and wherein further the comparing comprises determining if a request for a network resource is being made during a predefined time.

16. A parental control mechanism for limiting activities of one or more users of a computing device, the parental control mechanism performing steps comprising:
receiving a request to restrict network access based on the activities of the one or more users, the activities of the one or more users consisting of at least one of: failing to properly purchase a license to one or more software products installed on the computing device, failing to properly apply critical updates to one or more software products installed on the computing device, and attempting to access specific network resources during predetermined times; and
restricting network access for the one or more users, the one or more users comprising non-administrator and administrator users.

17. The parental control mechanism of claim 16, wherein the restricting network access comprises allowing network access directed to network resources that are necessary for correcting the activities of the one or more users.

18. The parental control mechanism of claim 16, wherein the restricting network access comprises redirecting network access to network resources that are necessary for correcting the activities of the one or more users.

19. The parental control mechanism of claim 16, performing further steps comprising displaying an in-band user notification associated with the restricted network access.

20. The parental control mechanism of claim 16, performing further steps comprising displaying an out-of-band user notification associated with the restricted network access.
